(19) United States
(12) Patent Application Publication
(10) Pub. No.: US 2016/0189574 A1
(43) Pub. Date: Jun. 30, 2016

(54) BACK NECK PANEL LABEL

(71) Applicant: Avery Dennison Retail Information Services, LLC, Mentor, OH (US)

(72) Inventor: Mathieu de Backer, Grottammare (IT)

(21) Appl. No.: 14/864,943

(22) Filed: Sep. 25, 2015

Related U.S. Application Data
(60) Provisional application No. 62/055,077, filed on Sep. 25, 2014.

(51) Int. Cl. G09F 3/02; A41D 27/08; A41B 1/08

(52) U.S. Cl. CPC G09F 3/02; A41B 1/08; A41D 27/08; G09F 2003/0208; G09F 2003/0282; G09F 2003/0225

(57) ABSTRACT

A woven label that is woven within a collared shirt or other apparel item, such that it is an integral part of the collared shirt is disclosed. Specifically, the woven label is woven directly into the back neck panel of the collared shirt. Thus, weaving the woven label into the back neck panel of the collared shirt eliminates the utilization of one or more separate labels. The woven label would then be an integral part of the collared shirt, and not able to be easily removed by a user.

### CROSS-REFERENCED TO RELATED APPLICATION(S)

The present application claims priority from U.S. Provisional Application No. 62/055,077 filed Sep. 25, 2014 which is incorporated by herein by reference in its entirety.

### FIELD OF THE INVENTION

The present invention relates generally to a woven label or a combination woven and sublimation label for an apparel item, collared shirt or other garment or fashion accessory. More particularly, the present disclosure relates to a woven label that is either woven directly in or within the back neck panel, such that it is an integral part of the garment or collared shirt, or one which may be transferred via heat and pressure with or without weaving which eliminates the utilization of a separate brand identification label currently found in apparel items. The present invention can be used to further enhance a theme, brand, promotion or design while providing traditional brand identification.

### BACKGROUND OF THE INVENTION

The manufacture of apparel items involves numerous steps, including forming a fabric, dyeing and finishing the fabric, cutting the fabric, and sewing the cut fabric into individual items of apparel or garments, such as a shirt, blouse, trousers, pants, jackets, or apparel accessories, e.g. scarfs, belts, hats, etc. Typically, during one of the last steps in the manufacturing process is the application of one or more labels. These labels are intended to be source identifiers, such as trademarks or brand information, to provide size or garment care information, or provide warnings or legal disclaimers.

Labels are sometimes adhesively affixed to the garment, but are more conventionally sewn into the garment, either on an open surface or along a hem or seam, such as where components of a garment or apparel item are affixed together to create a finished item. Labels that are adhesively affixed, however, cannot normally be affixed to items of apparel that must be dry cleaned or laundered as the adhesively affixed label can degrade during the dry cleaning or laundering process. Labels that must be sewn into garments normally require an additional step of affixing the label to the garment and the additional embroidered or printed label stock, all of which amounts to additional costs for the finished garment. Additionally, the labels typically must be sewn in a different area of the sewing facility or at an entirely different facility adding labor, handling and transportation costs to the garment or apparel item.

Another problem with labels or tags that are sewn into the apparel item or garment is that they must sometimes be located where they are visible, but are nevertheless uncomfortable to the wearer. For example, product tags used in shirts are sewn inside the neck area of the shirt. Depending upon how the tag is sewn, it may be also be uncomfortable for the wearer as it can potentially irritate the skin of the wearer. In such cases, wearers often remove these tags. As a result, product identification and care information is lost, and the garment is frequently damaged during the process of removing the tag.

In an attempt to overcome the above problems, there is a need for labels that are comfortable for the wearer which are not easily removed, or which may be damaged such as a result of cleaning attempts or deliberate activity by the consumer, resulting in the loss of product or brand identification, any regulatory details and care information. The present invention satisfies this need by producing a single woven label that is at least partly woven directly within the back neck panel of a garment or apparel item such as a collared shirt, such that it becomes an integral part of the collared shirt, thereby eliminating the utilization of a separate label.

### BRIEF SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a woven label that is at least partially woven within a collared shirt, such that it is a single, integral part of the collared shirt. Specifically, the woven label is woven directly into the back neck panel of the collared shirt. Thus, weaving the label into the back neck panel of the collared shirt eliminates the utilization of a separate label or labels. The woven label component would then be an integral part of the collared shirt, and not be able to be removed by a user without significant damage to the garment or apparel item.

In a preferred embodiment, the woven label is woven into the half-moon shape design of the back neck panel of a collared shirt, the shape accommodating the outline of the collar of the shirt, but the woven label could be woven in any suitable position within the collared shirt as is known in the art. In addition, the shape, semi-circular could accommodate the opening for a sleeve or arm portion, or used in pants or trousers and accommodate the leg opening.

In a further embodiment of the present invention, the woven label may be partially woven into the back neck panel of a collared shirt and other portions of the label, such as those necessary for compliance or care labeling may be affixed through the use of heat and pressure to hold the label to the shirt.

In a still further embodiment of the present invention a dye sublimated transfer is initially created on a fabric substrate and then additional weaving is provided to add other elements, such as brand or product identifiers to the substrate. The substrate is then cut and the label is then at least partially woven into the back neck panel of the collared shirt. By initially providing a dye sublimated substrate on fabric additional design features can be added to the label to be sewn into the garment or apparel item.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 illustrates a perspective view of a woven label in accordance with the disclosed architecture;

FIG. 2 illustrates a perspective view of the back neck panel of a collared shirt having an intermediate assembly disposed thereon in accordance with the disclosed architecture;

FIG. 3 illustrates a perspective view of the woven label woven into the back neck panel of the collared shirt to form an integral piece in accordance with the disclosed architecture;

FIG. 4 illustrates the label of the present invention attached to a garment; and

FIG. 5 shows a cross section of the label in connection with the present invention.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Labels or tags that are sewn into apparel and other garment items and accessories therefor and are typically located where they are visible, and may in some instances be inconvenient for the wearer. For example, product tags in dress shirts are sewn inside the neck area of the shirt. Depending upon how the tag is sewn, it may be also be uncomfortable for the wearer as the tag or label is in contact with the skin of the wearer. In such cases, wearers often remove these tags. As a result, product identification and care information can be lost, and the garment or apparel item is frequently damaged during the process of removing the tag. In an attempt to overcome the above problems, there is a need for labels that are comfortable for the wearer and are not easily removed resulting in the loss of product identification, regulatory or source details and care information.

In addition, there is a desire by brand owners to further promote their brand and enhance the particular garment to which the label has been attached. By creating such a unique label, a brand owner is also provided with a greater area or “landscape” in which to further embellish their brand, provide additional information to a prospective customer and to create an area for a story, script or other communication to enhance a consumer understanding of the product. In some instances, the structure of the present invention can significantly increase the available landscape for a manufacture to provide additional promotional, marketing, branding, sourcing or other information by more than one hundred percent when compared to conventional label assemblies.

The present invention can be used to facilitate compliance related information, such as sustainable souring of components from renewable goods, identification of fair labor practices, manufacturing and logistics details to trace the origin of the product through completion. The present invention can then be used similar to a map or story line to provide details relating to the product.

In addition, in yet another embodiment, scannable codes, glyphs or other components can be woven into the panel to provide for other user interaction, such as to sign up for mailing lists, being directed to user web sites or other sponsors that might provide other products of interest to the consumer. Counterfeit prevention measures may also be included such as with security threads as part of the weaving

The present invention satisfies this need by producing a woven label that is woven directly within the back neck panel of a collared shirt, such that it is an integral part of the collared shirt, which eliminates the utilization of a separate label that has historically been used for brand identification alone.

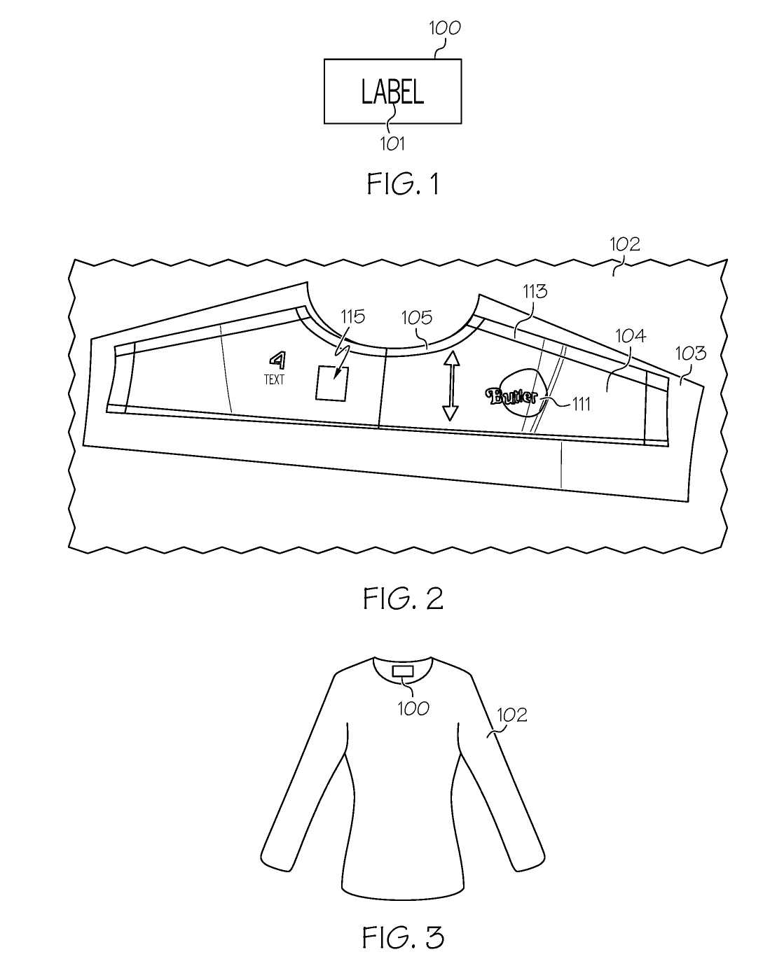

Referring initially to the drawings, FIGS. 1-5 illustrate a label 100 that is woven within a collared shirt or other garment. Using the label 100 as a care label for a collared shirt is merely one possible example and the same label 100 may be used for any suitable application. Thus, although the term “label” is used throughout the present disclosure for exemplary purposes, the term “label” may be any single item, or a group of items.

The label 100 is woven within a garment, typically a collared shirt 102, such that it is an integral part of the collared shirt 102 (as shown in FIG. 3). However, the garment can be any other suitable type of garment, apparel item or accessory known in the art without affecting the overall concept of the invention. The garment (i.e., collared shirt 102) includes a garment body and a brand label with information woven therein and secured to the garment body. Further, the garment can include additional labels within the scope of the present invention, such as size, content, and care instruction labels, etc. Additionally, the garment is manufactured of fabric or other suitable material as is known in the art.

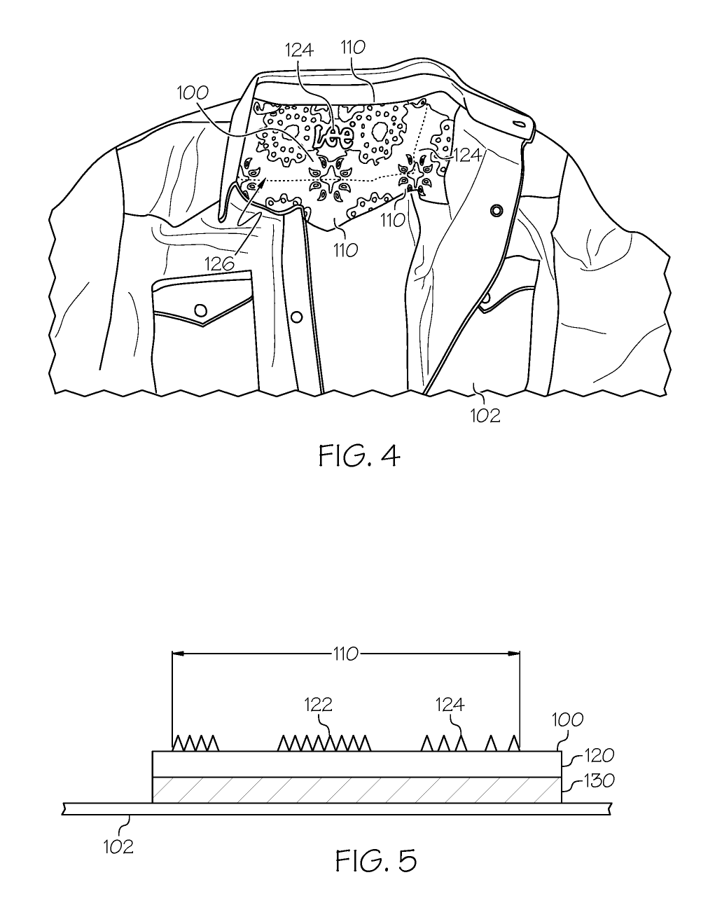

The label 100 is preferably located in a conspicuous area of the garment that is immediately visible to a consumer at a point of sale. For example, the label 100 is typically centrally located at the back of the neck or collar in the back neck panel 104 of the collared shirt 102 (as shown in FIGS. 2 and 4). However, the label 100 can be located at any suitable place on the collared shirt 102 as is known in the art. The back neck panel 104 is shown with a partially cylindrical area 105 which is intended to fit around the neck or collar portion of a garment. It should be understood that other shapes could be utilized and the current depiction and shape could be used around an arm opening or leg opening for example in pants or trousers. Still referring to FIG. 2, brand information may also be provided at 111, security threads may be used for example as part of the weaving 113 and scannable codes, RFID devices or the like could be provided at 115.

The label 100 is secured to the collared shirt 102 in any suitable manner such as sewing, stapling, weaving, etc. and in situations where the label may contain heat transfer components, such as with a dye sublimated label, the label may also be applied using heat and pressure in addition to weaving the label to the garment.

Typically, the label 100 is woven directly into the collared shirt 102 on all four sides of the label 100, such that the label 100 is an integral part of the shirt 102. Weaving the label 100 into the collared shirt 102 eliminates the utilization of a separate label. The woven label 100 would then be an integral part of the collared shirt 102, and not able to be removed by a user. The woven label 100 is typically woven into the back neck panel 104 of a collared shirt 102, but can be woven into any suitable position on the collared shirt 102 as is known in the art without affecting the overall concept of the invention.

Where the label 100 is woven all along the border as shown in FIG. 4 reference numeral 110. While the label 100 is woven all along the border, the label can be left unattached in the central area or additional weaving may be used to hold other areas of the label to the garment. In addition to weaving the label 100 to the garment 102, the unsecured areas of the label 100 may be secured to the garment by heat and pressure as will be described herein.

The label 100 typically includes a shaped body, any geometric shape may work depending on the requirements of the end user and product to which the label will be affixed, and indicia 101 woven into the body (as shown in FIG. 1). However, the label 100 can have any suitable shape as is known in the art without affecting the overall concept of the invention. The label 100 typically comprises fabric or any other suitable material as is known in the art. The indicia 101 are formed by threads woven into the fabric body of the label 100. Specifically, the indicia 101 are formed with a thread pattern having a plurality of vertically-extending, parallel threads. The woven threads run in an edge to edge direction for the small dimension of the label. However, any other suitable thread pattern can be utilized as is known in the art. The threads forming the indicia preferably have a color that contrasts with the threads forming the fabric body so that the indicia can be easily seen by the consumer. Further, the label is preferably relatively large in size so that consumers can immediately recognize the garment's brand, but any suitable size as is known in the art can be used.

The indicia 101 is usually brand indicia which includes alphanumeric characters forming brand names and logos, such as, for example, a trademark, trade name, company name, logo, symbol, or the like to be associated with the garment. The alphanumeric characters can comprise any suitable font. The indicia can alternatively or additionally include any other suitable information.

The label is woven in long continuous strips on a loom and then the individual labels are cut from the strip and can be applied to the back neck panel shape after being severed from the strip of labels. The labels are cut into shaped panels and then sewn in at the connection point of the garment, such as the back neck panel.

Returning to FIG. 2, the intermediate assembly 103 is shown disposed under a pattern 104 which will be used to shape the label 100 for attachment to the garment. The intermediate assembly can be a fabric material made of natural and or synthetic fibers or combinations thereof.

Reference is now directed to FIG. 5 which shows one possible cross section of the label to be used in accordance with the present invention. Label 100 has a fabric layer 120 which may be provided with an adhesive layer 130 in the event that in addition to weaving the label 100 may be further connected to the garment by heat and pressure. Weaving is shown at 110 passing through the label 100 to the garment 102. The fabric layer 120 of the label 100 is shown with woven patterns 122 such as brand owner information as well as background patterns 124 which can either be created by weaving or by dye sublimation process as understood in the art. See also FIG. 4 which shows the background pattern 124 and brand identification indicia 122. The back neck panel can be provided with other embellishments 126 to further enhance the brand, add additional aesthetic elements to the label, or create other promotions or marketing themes. The back neck panel can also be provided with compliance and regulatory information and can include information as to the product origin, compliance related issues such as labor, sustainable resources, etc.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A woven label for a garment, comprising:
a label comprising indicia; and
a garment comprising a garment body;
wherein the label is at least partially woven directly into the garment body.

2. The woven label of claim 1, wherein the garment is a collared shirt.

3. The woven label of claim 2, wherein the label is woven directly into a back neck panel of the collared shirt around all sides of the label.

4. The woven label of claim 3, wherein the back neck panel of the collared shirt comprises a half-moon shape design, and the label is woven directly into the half-moon shape design.

5. The woven label of claim 4, wherein the label forms an integral piece with the back neck panel of the collared shirt.

6. The woven label of claim 5, wherein the label is a woven label.

7. The woven label of claim 6, wherein the indicia on the label is a brand name.

8. The woven label of claim 6, wherein the label is woven into the back neck panel during the manufacturing process of the collared shirt.

9. The woven label of claim 8, wherein the label woven into the back neck panel of the collared shirt cannot be removed once woven into the collared shirt.

10. The woven label of claim 6, wherein the indicia on the label includes a background pattern.

11. A woven label for a garment, comprising:
a woven label comprising indicia; and
a collared shirt;
wherein the woven label is woven directly into the collared shirt.

12. The woven label of claim 11, wherein the woven label is woven directly into a back neck panel of the collared shirt.

13. The woven label of claim 12, wherein the back neck panel of the collared shirt comprises a half-moon shape design, and the woven label is woven directly into the half-moon shape design.

14. The woven label of claim 13, wherein the woven label forms an integral piece with the back neck panel of the collared shirt.

15. The woven label of claim 14, wherein the woven label is woven into the back neck panel during the manufacturing process of the collared shirt.

16. The woven label of claim 11, wherein the indicia on the woven label is a brand name.

17. A woven label for a garment, comprising:
a woven label comprising indicia; and
a collared shirt comprising a back neck panel;
wherein the woven label is woven directly into a back neck panel of the collared shirt and forms an integral piece with the back neck panel.

18. The woven label of claim 17, wherein the back neck panel of the collared shirt comprises a half-moon shape design, and the woven label is woven directly into the half-moon shape design.

19. The woven label of claim 17, wherein the woven label is woven into the back neck panel during the manufacturing process of the collared shirt.

20. The woven label of claim 17, wherein the indicia of the woven label includes brand information and a background pattern.

21. The woven label of claim 20, wherein the background pattern may be created by dye sublimation.

22. The woven label of claim 17, wherein the woven label is secured to a collard shirt by both weaving and heat and pressure.
